(19) United States
(12) Patent Application Publication
(10) Pub. No.: US 2006/0144493 A1
(43) Pub. Date: Jul. 6, 2006

(54) TIRE CHAIN ASSEMBLY

(76) Inventor: Gregory KAUFMAN, Green Oaks, IL (US)

Correspondence Address: CLAUSEN MILLER, P.C, SUITE 1600, 10S. LASALLE STREET, CHICAGO, IL, 60603, US

(21) Appl. No.: 10/905,412

(22) Filed: Jan. 3, 2005

(51) Int. Cl. B60C 11/00

(52) U.S. Cl. 152/225 R

(57) ABSTRACT

A tire chain assembly for enhancing tire traction is provided. The assembly does not require the car to be moved or placed on a jack to be installed. The tire chain assembly comprises a pair of parallel nylon straps connected by nylon cross straps bearing rivets or spikes to provide traction. A metal chain is permanently connected to a first cross strap by a cleat, extends through a series of hollow, cylindrical guides on each cross strap and terminates in a clip or other fastening means at the free end of the chain. Mushroom shaped cleats located at the other end of each cross strap are used to secure the tire chain assembly to the tire.

### FIELD OF THE INVENTION

This patent relates to a tire chain assembly for use on tires in bad weather. More particularly, this invention relates to a chain that can be easily installed on and removed from a tire without using a jack.

### DESCRIPTION OF THE RELATED ART

Tire traction enhancing devices are known in the art. For example, U.S. Pat. No. 1,046,272 discloses a device that can be attached to and detached from a tire and comprising a flexible mat and hooks for securing the mat to a wheel tread. U.S. Pat. No. 1,596,796 discloses an antiskid device comprising interlocked plates having outwardly projecting tongue portions that can be strapped to a tire with belts. U.S. Pat. No. 6,619,353 discloses an anti-slipping device comprising a series of U-shaped friction members formed of a synthetic resin and strapped to a tire via wires.

It is an object of the present invention to provide another type of traction enhancing apparatus that can be easily installed on and removed from a tire.

Another object of the invention is to provide a traction enhancing apparatus that can be installed without moving the car or using a jack.

Further and additional objects will appear from the description, accompanying drawings, and appended claims.

### SUMMARY OF THE INVENTION

The present invention is a tire chain assembly for enhancing tire traction in bad weather. The assembly does not require the car to be moved or placed on a jack to be installed.

The tire chain assembly comprises at least one strap extending around the perimeter (tread surface) of the tire, a plurality of cross-straps attached to the at least one perimeter strap, and a chain, strap or other securing means affixed to a first end of each of the cross straps and having a fixed end secured to a first end of the first cross strap by a first engagement means (preferably a mushroom shaped cleat) and a free end with a clip or other attachment means connected thereto.

The cross straps have first and second opposing ends and traction enhancing means such as rivets or spikes mounted on pads interposed between the first and second opposing ends. The assembly further comprises second engagement means, preferably mushroom shaped cleats, located at the second end of each cross strap.

Wrapping the free end of the chain around the first engagement means, extending the free end across the tire tread and wrapping it around the second engagement means of the first cross strap and of the other cross straps, and fastening the free end to the tire chain assembly secures the tire chain assembly to the tire.

Preferably the chain is secured to each cross strap except the first by a chain guide. Each chain guide comprises a hollow cylindrical portion having a bore that allows the chain to slide through.

Preferably the perimeter straps and the cross straps are made from nylon.

The scope of the invention also includes a method of enhancing the traction of a tire comprising the steps of:

(1) providing a tire chain assembly having at least one perimeter strap, a plurality of cross-straps attached to the at least one perimeter strap, said cross straps having first and second opposing ends and traction enhancing means interposed between the first and second opposing ends, said plurality of cross-straps including a first cross strap disposed at one end of the at least one perimeter strap and a last cross strap disposed at the other end of the at least one perimeter strap, means for securing the assembly to the tire, said securing means affixed to a first end of each of the cross straps and having a fixed end secured to a first end of the first cross strap by a first engagement means and a free end with attachment means connected thereto, and second engagement means located at the second end of each cross strap;

(2) draping the tire chain assembly over the tire so that the first and last cross straps hang down around the tire with the traction enhancing means extending away from the tire;

(3) wrapping the free end of the securing means around the first engagement means;

(4) bringing the free end across the tire tread and wrapping it around the second engagement means of the first cross strap;

(5) wrapping the free end around the other cross straps; and

(6) fastening the free end to the tire chain assembly.

### THE DRAWINGS

FIG. 1 is a top (road facing) view of the tire chain assembly of the present invention.

FIG. 2 is a bottom (tire facing) view of the tire chain assembly of FIG. 1.

FIG. 3 is a perspective view the tire chain assembly of FIG. 1 installed on a tire (outer side of tire shown)

FIG. 4 is a perspective view the tire chain assembly of FIG. 1 installed on a tire (inner, car side of tire shown).

### DETAILED DESCRIPTION OF THE INVENTION

The invention is a tire chain assembly for increasing tire traction in bad weather. The tire chain assembly does not require the car to be moved or placed on a jack to be installed.

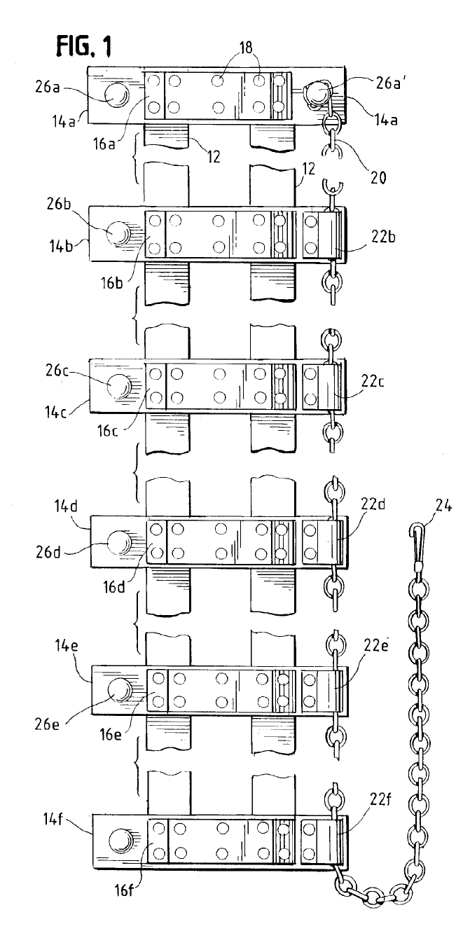

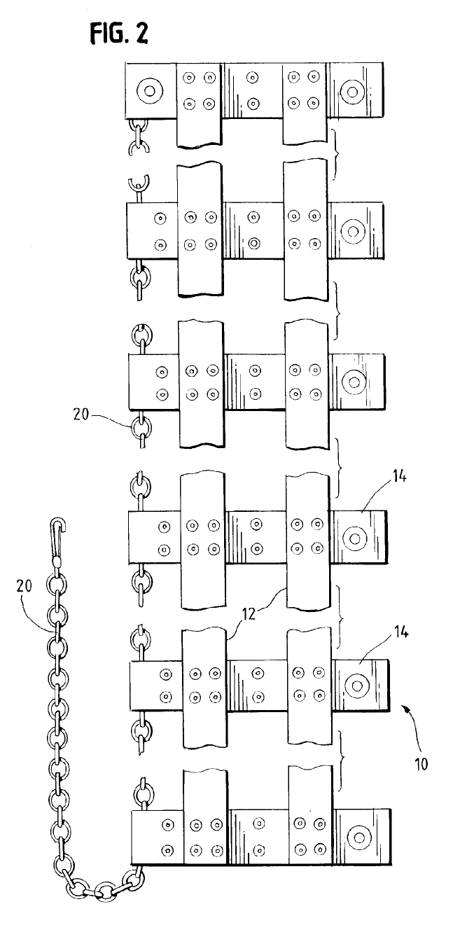

Turning to the drawings and, in particular, FIGS. 1 and 2, there is shown a preferred embodiment of the present invention. The tire chain assembly 10 comprises a pair of parallel nylon straps 12 (perimeter straps) connected by nylon cross straps 14. The perimeter straps 12 are sized so as to extend almost all the way around the tire for which they will be used. Pads 16 are located at the intersection of the perimeter straps 12 and cross straps 14, between the first and second opposing ends of the cross-straps 14, on the side of the cross straps 14 that will face the road. The pads 16 contain rivets, spikes 18 or other means for enhancing traction.

Six cross straps, designated 14a-f for convenience, are shown in the figures, although any suitable number of cross-straps 14 may be used. When the assembly 10 is installed on a tire the cross straps 14 extend laterally across the tire tread. A metal chain 20 or other securing means is permanently connected to a first cross strap 14a located at one end of the perimeter straps 12 by a first engagement means, such as a mushroom shaped cleat 26a′ (FIG. 1). The chain 20 extends from cleat 26a′ through a series of guides 22b-f located on the top (road facing) side of each cross strap 14 at a first, inner end of each cross-strap 14 and terminates in a clip 24 or other fastener located at the free end of the chain 20. The free end of the chain 20 should be long enough to extend across the tire tread and connect each of the cleats 26a-f located on the second, outer end of each cross strap 14a-f. Alternatively, a heavy strap, cord or other suitable means may be used instead of the chain 20 to secure the tire chain assembly 10 to the tire 28. The free end 24 may be made detachable from the rest of the chain 20 for easy storage and handling.

Engagement means such as cleats 26a-f are located at the opposite, second end of each cross strap 14 and are used to secure the tire chain assembly 10 as explained below. The cleats 26 can be any type of cleat having a wide head and narrow body for securing a chain, such as the mushroom type cleats shown in the drawing, boat type cleats, or any other suitable cleat.

Each chain guide 22 is made from a rectangular piece of metal that has been rolled at one end top form a hollow cylindrical body having a bore that allows the chain 20 to slide through easily. The flat portion of each chain guide is mounted to the cross straps 14b-f near their first, inner end by rivets.

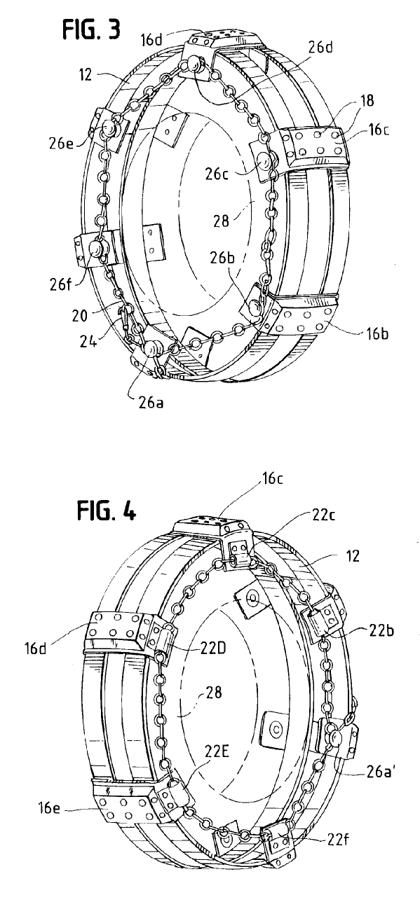

To install and secure the tire chain assembly 10, the assembly 10 is draped over the tire 28 of a parked car so that the first and last cross straps 14a, 14f of the assembly 10 hang down around the tire 28. The chain 20 should be located on the inner side of the tire (toward the car; see FIG. 4) and the mushroom cleats 26a-f should be located on the outer side of the tire (FIG. 3). Next, the user reaches around to the inside of the tire 28, grabs the free end of the chain 20 and wraps it around the first engagement means (cleat 26a′) on the first cross strap 14a located at the other end of the assembly 10. Then the user pulls the free end of the chain 20 around to the outside of the tire 28 (across the tire tread) and wraps the chain 20 around the mushroom cleat 26a located at the second, outer end of the first cross strap 14a. The user then wraps the chain 20 around each of the remaining cleats 26f-b on the outside of the tire 28, making a full circle. Finally, the user attaches the tire chain clip 24 to a link on the chain 20 so that the chain is securely fastened to the tire 28.

To remove the tire chain assembly 10, the clip 24 is unfastened from the chain 20 on the outer side of the tire (FIG. 3) and disconnected from mushroom cleats 26a-f. The car then may be rolled forward or backward until it is free of the tire chain assembly 10.

The tire chain assembly 10 may be made available in different sizes to accommodate different sized tires, including passenger car tires and light truck and sport utility vehicle tires. In an alternative embodiment (not shown), the tire chain assembly 10 can be modified by adding or removing segments to accommodate tires of different diameters.

The tire chain assembly 10 can also be used as a traction mat without attaching the assembly 10 to a tire. To use the tire chain assembly 10 as a traction mat the assembly 10 is simply placed on the ground adjacent the tire so that the tire will roll over the assembly 10 when the car is first moved.

Other modifications and alternative embodiments of the invention are contemplated which do not depart from the scope of the invention as defined by the foregoing teachings and appended claims. It is intended that the claims cover all such modifications that fall within their scope.

What is claimed is:

1. A tire chain assembly for enhancing the traction of a tire having a tire tread, comprising:
at least one perimeter strap;
a plurality of cross-straps attached to the at least one perimeter strap, said cross straps having first and second opposing ends and traction enhancing means interposed between the first and second opposing ends, said plurality of cross-straps including a first cross strap disposed at one end of the at least one perimeter strap;
means for securing the assembly to the tire, said securing means affixed to a first end of each of the cross straps and having a fixed end secured to a first end of the first cross strap by a first engagement means and a free end with attachment means connected thereto; and
second engagement means located at the second end of each cross strap;
wherein wrapping the free end of the securing means around the first engagement means, extending the free end across the tire tread and wrapping it around the second engagement means of the first cross strap and of the other cross straps, and fastening the free end to the tire chain assembly secures the tire chain assembly to the tire.

2. The tire chain assembly of claim 1 wherein the securing means is a chain.

3. The tire chain assembly of claim 2 wherein the engagement means are cleats having a relatively larger head portion and a relatively small body portion attached to the cross straps.

4. The tire chain assembly of claim 2 wherein the chain is secured to each cross strap except the first cross strap by a chain guide.

5. The tire chain assembly of claim 4 wherein each chain guide comprises a hollow cylindrical portion having a bore that allows the chain to slide through.

6. The tire chain assembly of claim 1 wherein the traction enhancing means are rivets.

7. The tire chain assembly of claim 1 wherein the traction enhancing means are spikes.

8. The tire chain assembly of claim 1 wherein the number of perimeter straps is two.

9. The tire chain assembly of claim 1 wherein the at least one perimeter strap and the cross straps are made from nylon.

10. A method of enhancing the traction of a tire having a tire tread, comprising:
providing a tire chain assembly having at least one perimeter strap, a plurality of cross-straps attached to the at least one perimeter strap, said cross straps having first and second opposing ends and traction enhancing means interposed between the first and second opposing ends, said plurality of cross-straps including a first cross strap disposed at one end of the at least one perimeter strap and a last cross strap disposed at the other end of the at least one perimeter strap, means for securing the assembly to the tire, said securing means affixed to a first end of each of the cross straps and having a fixed end secured to a first end of the first cross strap by a first engagement means and a free end with attachment means connected thereto, and second engagement means located at the second end of each cross strap;
draping the tire chain assembly over the tire so that the first and last cross straps hang down around the tire with the traction enhancing means extending away from the tire;
wrapping the free end of the securing means around the first engagement means;
bringing the free end across the tire tread and wrapping it around the second engagement means of the first cross strap;
wrapping the free end around the other cross straps; and
fastening the free end to the tire chain assembly.
